(19) United States
(12) Patent Application Publication
(10) Pub. No.: US 2026/0196737 A1
(43) Pub. Date: Jul. 9, 2026

(54) BASE STATION ANTENNA AND BASE STATION

(71) Applicant: HUAWEI TECHNOLOGIES CO., LTD., Shenzhen (CN)

(72) Inventors: Cheng Zhang, Shenzhen (CN); Xin Feng, Chengdu (CN); Chuanhui Ma, Chengdu (CN); Weimin Chen, Shenzhen (CN)

(21) Appl. No.: 19/552,493

(22) Filed: Feb. 27, 2026

Related U.S. Application Data
(63) Continuation of application No. PCT/CN2024/110106, filed on Aug. 6, 2024.

(30) Foreign Application Priority Data
Aug. 30, 2023 (CN) 202311128136.6

(51) Int. Cl. H01Q 19/06; H01Q 1/24; H01Q 3/36

(52) U.S. Cl. CPC H01Q 19/062; H01Q 1/246; H01Q 3/36

(57) ABSTRACT

Embodiments of this application provide a base station antenna and a base station. The base station antenna includes a first antenna array, a metasurface lens, and a second antenna array. The metasurface lens is located between a first radiator of a radiating element of the first antenna array and the second antenna array. The metasurface lens is configured to: reflect a radiation signal of the first antenna array, and perform wavefront phase modulation and transmission on a radiation signal of the second antenna array, so that the radiation signal of the second antenna array that passes through the metasurface lens is approximately focused into a plane wave. The base station includes the base station antenna.

### CROSS-REFERENCE TO RELATED APPLICATIONS

This application is a continuation of International Application No. PCT/CN2024/110106, filed on August 06, 2024, which claims priority to Chinese Patent Application No. 202311128136.6, filed on August 30, 2023. The disclosures of the aforementioned applications are hereby incorporated by reference in their entireties.

### TECHNICAL FIELD

This application relates to the field of antenna technologies, and in particular, to a base station antenna and a base station.

### BACKGROUND

With continuous evolution of mobile communication technologies, a shared-aperture array antenna becomes an inevitable trend. A design of the shared-aperture array antenna can implement antenna installation platform consolidation without increasing a quantity of antenna installation platforms and an area of the antenna installation platform, and can fully utilize combined advantages of high-frequency large bandwidth and low-frequency long-distance coverage. However, a conventional shared-aperture array antenna still has the following problems: An antenna metric deteriorates, for example, a gain loss exists, or crosstalk exists between inter-frequency antennas. Blockage and structural interference exist between antennas of different bands.

### SUMMARY

Embodiments of this application provide a base station antenna and a base station, to overcome the foregoing defects of a conventional solution.

According to a first aspect, this application provides a base station antenna, including a first antenna array, a metasurface lens, and a second antenna array. The metasurface lens is located between a first radiator of a radiating element of the first antenna array and the second antenna array. The metasurface lens is configured to: reflect a radiation signal of the first antenna array, and perform wavefront phase modulation and transmission on a radiation signal of the second antenna array, so that the radiation signal of the second antenna array that passes through the metasurface lens is approximately focused into a plane wave.

In this solution, the metasurface lens is disposed between the first antenna array and the second antenna array, and through reflection, transmission, and wavefront phase modulation by the metasurface lens, both the first antenna array and the second antenna array can operate, to implement a shared-aperture array antenna. Because the metasurface lens does not block the second antenna array located behind the first antenna array, defects of mutual blockage of antennas and mutual interference in antenna performance in a conventional solution are avoided. The first antenna array, the metasurface lens, and the second antenna array are properly assembled, so that structural interference can be avoided. Because the metasurface lens can approximately focus the radiation signal of the second antenna array into the plane wave through the wavefront phase modulation, a gain of the second antenna array can be improved.

In an implementation of the first aspect, the base station antenna includes a feeding structure and a feeding network, both the feeding structure and the feeding network are located on a side of the metasurface lens facing the first radiator, and the feeding structure connects the first radiator and the feeding network. In this solution, a position of the metasurface lens can be properly configured based on an existing structure of the base station antenna, and therefore, can be compatible with the existing structure of the base station antenna, to ensure that the metasurface lens can function effectively.

In an implementation of the first aspect, the base station antenna includes a feeding structure and a feeding network, the feeding structure passes through the metasurface lens, the feeding network is located on a side of the metasurface lens facing the second antenna array, and the feeding structure connects the first radiator and the feeding network. In this solution, a position of the metasurface lens can be properly configured based on an existing structure of the base station antenna, and therefore, can be compatible with the existing structure of the base station antenna, to ensure that the metasurface lens can function effectively.

In an implementation of the first aspect, the metasurface lens includes a dielectric layer, the dielectric layer is provided with a metal grid, the metal grid is arranged in an intersecting manner and encloses a plurality of regions, each region is provided with one metasurface unit, a specific gap exists between the metasurface unit in each region and a boundary of the region, the metal grid is configured to reflect the radiation signal of the first antenna array, and the metasurface unit is configured to perform wavefront phase modulation and transmission on the radiation signal of the second antenna array. In this solution, a structure of the metasurface lens is properly configured, so that the metasurface lens has a frequency selective characteristic. In this way, the metasurface lens can be transmissive for incident waves in some frequency bands and reflective for incident waves in some other frequency bands, so that transmission and reflection of an incident electromagnetic wave can be effectively controlled, and the metasurface lens can function effectively in the base station antenna.

In an implementation of the first aspect, the dielectric layer includes a plurality of dielectric sub-layers that are sequentially stacked, at least one of the dielectric sub-layers is provided with the metal grid, and when at least two of the dielectric sub-layers are provided with the metal grid, metal grids on all of the dielectric sub-layers overlap; and two opposite sides of each dielectric sub-layer along a thickness direction of the dielectric sub-layer each are provided with a metasurface pattern, and a plurality of metasurface patterns arranged along the thickness direction form one metasurface unit. In this solution, a structure of the metasurface lens is properly configured, so that the metasurface lens can function effectively. The metasurface lens having the multi-layer structure may be used as a multi-order spatial filter, to expand bandwidth and improve frequency selectivity.

In an implementation of the first aspect, in the plurality of dielectric sub-layers, a surface of a dielectric sub-layer adjacent to the first radiator is provided with the metal grid. The metal grid is disposed at a position close to the first radiator, so that reflection of the radiation signal of the first antenna array can be ensured, and a loss of the radiation signal of the first antenna array can be reduced.

In an implementation of the first aspect, structures of all of metasurface patterns on a same dielectric sub-layer are not completely the same. In this solution, each metasurface pattern on the same dielectric sub-layer may be equivalent to a resonator. Connecting the metasurface patterns (or referred to as a plurality of resonators) in series can enable the metasurface unit to achieve a specified phase shift. A design of the metasurface pattern on the metasurface unit may be determined based on a phase shift to be imparted to an electromagnetic wave that passes through the metasurface unit. The structures of the metasurface patterns on the metasurface unit are not completely the same, so that a corresponding phase shift can be imparted to the electromagnetic wave that passes through the metasurface unit, to meet a product requirement.

In an implementation of the first aspect, structures of a plurality of metasurface patterns on a same metasurface unit are not completely the same. In this solution, each metasurface pattern on the same metasurface unit may be equivalent to a resonator. Connecting the metasurface patterns (or referred to as a plurality of resonators) in series can enable the metasurface unit to achieve a specified phase shift. A design of the metasurface pattern on the metasurface unit may be determined based on a phase shift to be imparted to an electromagnetic wave that passes through the metasurface unit. The structures of the metasurface patterns on the metasurface unit are not completely the same, so that a corresponding phase shift can be imparted to the electromagnetic wave that passes through the metasurface unit, to meet a product requirement.

In an implementation of the first aspect, the first antenna array includes a plurality of groups of first radiators, and each group of first radiators includes a plurality of first radiators. The base station antenna includes a plurality of digital channels, each digital channel is electrically connected to all of first radiators in one group of first radiators, and the plurality of digital channels are configured to implement horizontal beam sweeping of the first antenna array by preconfiguring a phase shift. In this solution, the first antenna array uses a digital beamforming architecture, which may be compatible with a design of an existing base station antenna.

In an implementation of the first aspect, the second antenna array includes a plurality of groups of second radiators arranged along a first direction, each group of second radiators includes a plurality of second radiators arranged along a second direction, and the second direction is perpendicular to the first direction. The base station antenna includes a plurality of analog channels, each analog channel includes an analog phase shifter and a switch, the analog phase shifter in each analog channel is electrically connected to all of second radiators in one group of second radiators through the switch, and the plurality of analog channels are configured to: implement horizontal beam sweeping of the second antenna array through the analog phase shifter, and implement vertical beam sweeping of the second antenna array by switching the switch. The metasurface lens includes the dielectric layer and metasurface units, the metasurface lens has a first symmetry axis along the first direction, the metasurface units in the metasurface lens are distributed in an array along the first direction and the second direction, each column along the second direction in the array is symmetric about the first symmetry axis, and structures of metasurface units in each column along the first direction in the array are the same. In this solution, the second antenna array uses an analog beamforming architecture, which may be compatible with a design of an existing base station antenna. A design of the metasurface lens can meet a wavefront phase modulation requirement for the radiation signal of the second antenna array, and approximately focus the radiation signal of the second antenna array into a plane wave, to improve a gain of the second antenna array.

In an implementation of the first aspect, the second antenna array includes a plurality of sub-arrays, the plurality of sub-arrays are arranged in an array along a first direction and a second direction, each sub-array includes a plurality of second radiators arranged along the first direction, and the second direction is perpendicular to the first direction. The base station antenna includes a plurality of analog channels, each analog channel includes an analog phase shifter and a switch, the analog phase shifter in each analog channel is electrically connected to all of second radiators in one sub-array through the switch, the plurality of analog channels are configured to implement vertical beam sweeping of the second antenna array through the analog phase shifter, and the plurality of analog channels are further configured to: implement first-stage horizontal beam sweeping of the second antenna array by switching the switch, and implement second-stage horizontal beam sweeping of the second antenna array through the analog phase shifter. The metasurface lens includes the dielectric layer and metasurface units, the metasurface lens has a first symmetry axis along the first direction and a second symmetry axis along the second direction, the metasurface units in the metasurface lens are distributed in an array along the first direction and the second direction, each column along the second direction in the array is symmetric about the first symmetry axis, and each column along the first direction in the array is symmetric about the second symmetry axis. In this solution, the second antenna array uses an analog beamforming architecture, which may be compatible with a design of an existing base station antenna. A design of the metasurface lens can meet a wavefront phase modulation requirement for the radiation signal of the second antenna array, and approximately focus the radiation signal of the second antenna array into a plane wave, to improve a gain of the second antenna array.

In an implementation of the first aspect, the first radiator has a passive electromagnetic cancellation structure. In this way, signal blockage from the first antenna array to the second antenna array can be reduced.

In an implementation of the first aspect, the base station antenna includes a first radome and a second radome, the first antenna array and the metasurface lens are located in the first radome, and the second antenna array is located in the second radome. In this solution, different array antennas can be decoupled and arranged, to implement flexible deployment.

According to a second aspect, an embodiment of this application provides a base station, including the base station antenna. In this solution, a shared-aperture array antenna can be implemented, defects of mutual blockage of antennas and mutual interference in antenna performance are avoided, a problem of structural interference can be avoided, and an antenna gain can be improved. In this solution, antenna arrays on different frequency bands can be independently deployed, to implement a decoupled design and flexible deployment of antennas on different frequency bands, reduce a quantity of channels of a frequency band 2 antenna, and reduce costs.

### BRIEF DESCRIPTION OF DRAWINGS

FIG. 1 shows an application scenario in which a base station performs wireless communication with a terminal;

FIG. 2 shows an assembly structure of a base station according to an embodiment of this application;

FIG. 3 shows an internal framework structure of a part of the base station in FIG. 2;

FIG. 4 shows an internal framework structure of a base station antenna according to an embodiment of this application;

FIG. 5 is a schematic exploded view of a structure of a metasurface lens in the base station antenna in FIG. 4;

FIG. 6 is a diagram of a partially enlarged structure of a position A viewed in a direction B in FIG. 4;

FIG. 7 is a principle diagram of reflection, transmission, and focusing functions of a metasurface lens according to this embodiment;

FIG. 8 is another principle diagram of reflection, transmission, and focusing functions of a metasurface lens according to this embodiment;

FIG. 9 is a diagram of a top-view positional relationship among a first antenna array, a metasurface lens, and a second antenna array in a base station antenna in Embodiment 1;

FIG. 10 is a diagram of a side-view positional relationship among a first antenna array, a metasurface lens, and a second antenna array in a base station antenna in Embodiment 1;

FIG. 11 is a diagram of a circuit architecture used by a first antenna array in Embodiment 1;

FIG. 12 is a diagram of a circuit architecture used by a second antenna array in Embodiment 1;

FIG. 13 is a diagram of vertical beam sweeping of a second antenna array in Embodiment 1;

FIG. 14 shows a distribution pattern of metasurface units of a metasurface lens in Embodiment 1;

FIG. 15 shows a phase distribution generated in a frequency band of a second antenna array by each column of metasurface units in the metasurface lens arranged along a second direction, based on the design shown in FIG. 14;

FIG. 16 shows that a metasurface lens in Embodiment 1 may be equivalent to one lens;

FIG. 17 is a diagram of a top-view positional relationship among a first antenna array, a metasurface lens, and a second antenna array in a base station antenna in Embodiment 2;

FIG. 18 is a diagram of a side-view positional relationship among a first antenna array, a metasurface lens, and a second antenna array in a base station antenna in Embodiment 2;

FIG. 19 is a diagram of a circuit architecture used by a second antenna array in Embodiment 2;

FIG. 20 shows a two-stage sweeping manner of a second antenna array in Embodiment 2;

FIG. 21 shows that a metasurface lens in Embodiment 2 is formed by arranging a plurality of lens sub-arrays 22c in an array along a first direction and a second direction respectively;

FIG. 22 shows that a metasurface lens in Embodiment 2 may be equivalent to one lens; and

FIG. 23 shows a phase distribution generated in a frequency band of a second antenna array by a lens sub-array in the metasurface lens, based on the design shown in FIG. 21.

### DESCRIPTION OF EMBODIMENTS

The following describes technical solutions in embodiments of this application with reference to the accompanying drawings in embodiments of this application. It is clear that the described embodiments are merely a part rather than all of embodiments of this application.

In embodiments of this application, the terms such as "first" and "second" are merely used to distinguish with components, and cannot be understood as an indication or implication of relative importance of the components or an implication of a quantity of indicated technical features. Therefore, features defined by "first", "second", or the like may explicitly or implicitly include one or more features. In descriptions of embodiments of this application, unless otherwise specified, "a plurality of (layers)" means two (layers) or more (layers).

In embodiments of this application, the terms such as "on", "under", "front", "front side", "back", and "back side" are defined with respect to a schematic placement position of a structure in the accompanying drawings. It should be understood that these directional terms are relative concepts, are relative descriptions and clarifications, and may correspondingly change based on a change of the placement position of the structure.

In embodiments of this application, unless otherwise specified, "and/or" describes only an association relationship between associated objects and indicates that three relationships may exist. For example, A and/or B may indicate the following three cases: Only A exists, both A and B exist, and only B exists.

Embodiments of this application relate to a base station and a base station antenna. The following first describes the base station, and then describes a general structure of the base station antenna.

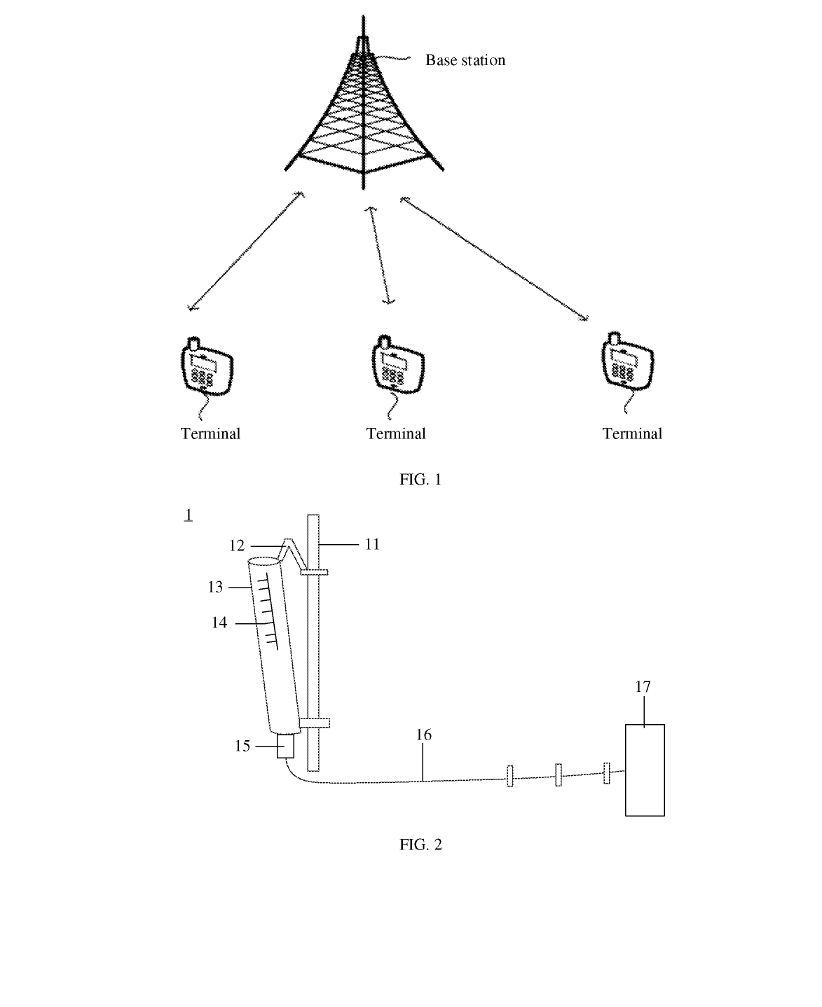

FIG. 1 shows an application scenario in which a base station performs wireless communication with a terminal. As shown in FIG. 1, the base station is configured to perform cell coverage of a radio signal, to implement communication between a terminal device and a wireless network. Specifically, the base station may be a base transceiver station (base transceiver station, BTS) in a global system for mobile communications (global system for mobile communications, GSM) or a code division multiple access (code division multiple access, CDMA) system, may be a NodeB (NodeB, NB) in a wideband code division multiple access (wideband code division multiple access, WCDMA) system, may be an evolved NodeB (evolved NodeB, eNB) in a long term evolution (long term evolution, LTE) system, or may be a radio controller in a cloud radio access network (cloud radio access network, CRAN) scenario. Alternatively, the base station may be a relay station, an access point, a vehicle-mounted device, a wearable device, a g node (gNodeB or gNB) in a new radio (new radio, NR) system, a base station in a future evolved network, or the like. This is not limited in embodiments of this application.

The base station is equipped with a base station antenna to implement signal transmission in space. FIG. 2 shows structural composition of a base station antenna equipped for the base station in FIG. 1. As shown in FIG. 2, the base station 1 may include a pole 11, a pole support 12, a radome 13, an antenna array 14, a radio frequency processing unit 15, a cable 16, and a baseband processing unit 17. The base station antenna may include the pole support 12, the radome 13, the antenna array 14, and a feeding network, a reflector plate, and the like that are to be described below.

The pole 11 may be fastened to the ground. The pole support 12 connects the pole 11 and the radome 13. The radome 13 is fastened to the pole 11 through the pole support 12. The antenna array 14 may be mounted in the radome 13. The feeding network may be further mounted in the radome 13. The radome 13 has a good electromagnetic wave transmission characteristic and environmental weatherability, and can protect components mounted in the radome 13.

The antenna array 14 is configured to radiate and receive antenna signals. The antenna array 14 may include a plurality of radiating elements that are arranged in an array according to a specific rule. Each radiating element can radiate and receive electromagnetic waves. The radiating element may include an antenna element. In the antenna array 14, operating frequency bands of different radiating elements may be the same or different. The radiating element may include a radiator (for example, a radiation arm) and a feeding structure (for example, including a balun) connected to each other. The radiator is configured to radiate and receive signals. The feeding structure connects the radiator and the feeding network, to transmit, to the radiator, an electrical signal transmitted by the feeding network, and transmit, to the feeding network, a signal received by the radiator.

The base station antenna may further include the reflector plate. The reflector plate may also be referred to as a backplane, an antenna panel, a reflection surface, or the like. For example, the reflector plate may be manufactured by using a metal material. The radiating element may be mounted on a surface on one side of the reflector plate. When the radiating element receives an antenna signal, the reflector plate may reflect and focus the antenna signal at a receiving point, to implement directional receiving. When the radiating element transmits an antenna signal, the reflector plate may implement directional transmission of the antenna signal. The reflector plate can enhance a capability of receiving or transmitting an antenna signal of the radiating element, and can further block and shield an interference effect of another signal from a back (where the back refers to a side of the reflector plate facing away from the radiating element) of the reflector plate on the antenna signal, to improve an antenna gain.

The radio frequency processing unit 15 (which may also be referred to as a remote radio unit (remote radio unit, RRU)) may be connected to the feeding network via a jumper, and is electrically connected to the antenna array 14 via the feeding network. The feeding network (which is further described below) may be used as a signal transmission path between the radio frequency processing unit 15 and the antenna array 14. The radio frequency processing unit 15 may be electrically connected to the baseband processing unit 17 (which may also be referred to as a baseband unit (baseband unit, BBU)) via the cable 16 (for example, an optical cable). As shown in FIG. 2, both the radio frequency processing unit 15 and the baseband processing unit 17 may be located outside the radome 13, and the radio frequency processing unit 15 may be located at a near end of the base station antenna.

The radio frequency processing unit 15 may perform frequency selection, amplification, and down-conversion on an antenna signal received by the antenna array 14, convert a processed antenna signal into an intermediate frequency signal or a baseband signal, and send the intermediate frequency signal or the baseband signal to the baseband processing unit 17. The radio frequency processing unit 15 may alternatively perform up-conversion and amplification on the baseband processing unit 17 or an intermediate frequency signal, convert the baseband processing unit 17 or a processed intermediate frequency signal into an electromagnetic wave via the antenna array 14, and send the electromagnetic wave.

A structure of the base station 1 shown in FIG. 2 is merely an example. Actually, a structure of the base station in embodiments of this application may be flexibly designed based on a product requirement, and is not limited to the foregoing descriptions. For example, the base station may alternatively not include the pole 11, and the radome 13 may be fastened to a tower through the pole support 12. For example, for a high-frequency antenna array, an RRU and an antenna array may be integrated together to form an active antenna unit (active antenna unit, AAU), and the AAU may be connected to a BBU through an optical fiber.

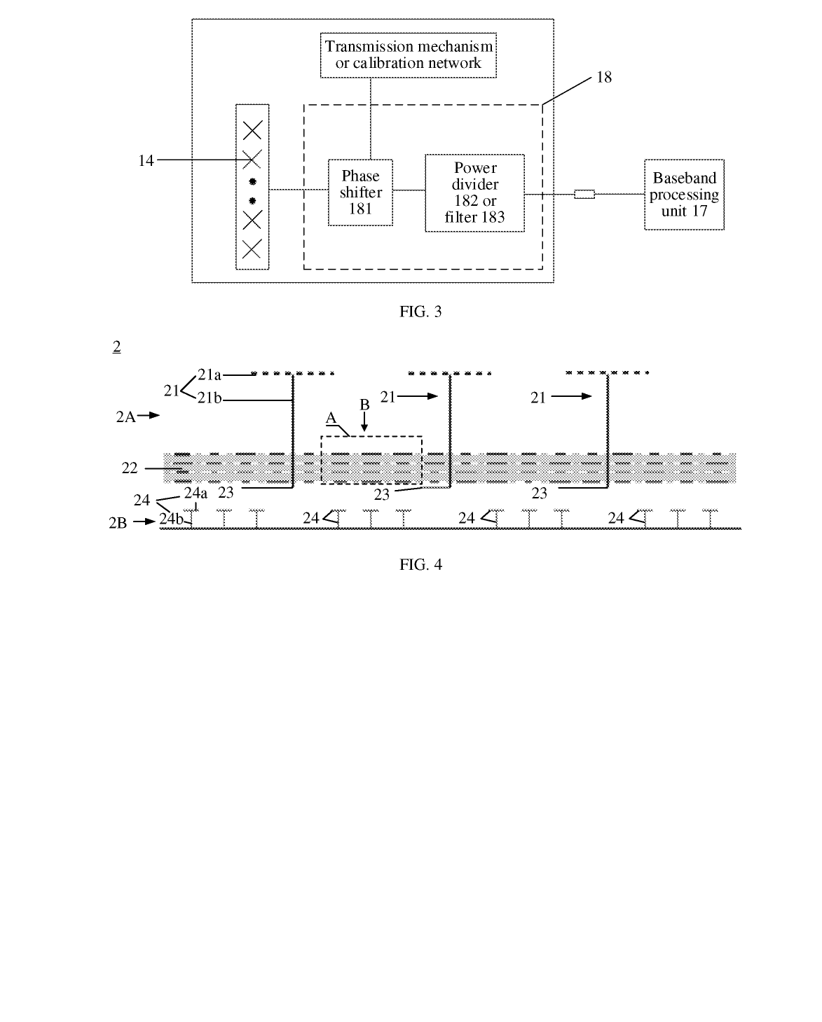

FIG. 3 may show an internal framework structure of a part of the base station 1 in FIG. 2. As shown in FIG. 3, the antenna array 14 of the base station 1 is connected to a feeding network 18. The feeding network 18 may implement different radiation beam pointing directions through a transmission mechanism, or may be connected to a calibration network to obtain a calibration signal required by the base station 1. The feeding network 18 may feed a signal to the antenna array 14 based on a specific amplitude and phase, or send a received signal to the baseband processing unit 17 based on a specific amplitude and phase.

For example, the feeding network 18 may include a phase shifter 181, and the phase shifter 181 is configured to change a maximum radiation direction of an antenna signal. The feeding network 18 may further include a module configured to extend performance, for example, a power divider 182. The power divider 182 is configured to combine a plurality of signals into one signal, and transmit the signal through the antenna array 14. Alternatively, the power divider 182 divides one signal into a plurality of signals, for example, divides, based on different frequencies, a signal received by the antenna array 14 into a plurality of signals, and transmits the plurality of signals to the baseband processing unit 17 for processing. The feeding network 18 may further include a filter 183, configured to filter out an interference signal. The feeding network 18 may further include a combiner. The feeding network 18 may further include a transmission line in any form, for example, a coaxial line, a strip line, or a microstrip.

The following describes an internal structure of the base station antenna in embodiments of this application.

FIG. 4 shows a general internal structure of a base station antenna 2 according to an embodiment of this application. As shown in FIG. 4, the base station antenna 2 may include a first antenna array 2A, a metasurface lens (Metalens) 22, and a second antenna array 2B. The first antenna array 2A and the second antenna array 2B may be arranged in a stacked manner, and the two antenna arrays use a shared-aperture design. Operating frequency bands of the first antenna array 2A and the second antenna array 2B may be different. A range of the operating frequency band of the first antenna array 2A may be several hundred MHz to an X band, and the operating frequency band of the second antenna array 2B may be not lower than the operating frequency band of the first antenna array 2A. For example, the first antenna array 2A operates in a low frequency band, for example, a frequency band such as 700 MHz, 900 MHz, 1.6 GHz, 2.1 GHz, or 3.5 GHz; and the second antenna array 2B operates in a high frequency band, for example, a frequency band such as 26 GHz, 28 GHz, or an FR2 frequency band defined by 3GPP. The first antenna array 2A may be referred to as a frequency band 1 antenna for short, and the second antenna array 2B may be referred to as a frequency band 2 antenna for short.

In an implementation of this embodiment, the first antenna array 2A and the metasurface lens 22 may be located in one radome, and the second antenna array 2B is located in another radome. In this way, the second antenna array 2B can be decoupled from the first antenna array 2A, to implement flexible deployment based on a requirement. When there is no second antenna array 2B, the first antenna array 2A can operate normally. When the second antenna array 2B is needed, the second antenna array 2B is assembled on a back of the first antenna array 2A.

In another implementation of this embodiment, the first antenna array 2A, the metasurface lens 22, and the second antenna array 2B may be located in a same radome, and the second antenna array 2B is not connected to either the first antenna array 2A or the metasurface lens 22, or the second antenna array 2B is detachably connected to the metasurface lens 22. A structure (for example, a support) connected to the metasurface lens 22 of the second antenna array 2B may avoid a signal radiation path of the second antenna array 2B as much as possible to avoid a signal loss. For example, the structure may be connected to an edge of the metasurface lens 22. In this implementation, the second antenna array 2B can also be decoupled from the first antenna array 2A, to implement flexible deployment based on a requirement.

As shown in FIG. 4, the first antenna array 2A may include a plurality of first radiating elements 21 arranged according to a specific rule. Frequency bands of the first radiating elements 21 may be consistent, or a frequency band of at least one first radiating element 21 is different from a frequency band of another first radiating element 21. The first radiating element 21 may include a first radiator 21a and a feeding structure 21b, and the first radiator 21a the feeding structure 21b are connected to each other. It may be understood that, in FIG. 4, a horizontal line represents the first radiator 21a, and a vertical line represents the feeding structure 21b. This is merely an example, and is not intended to limit specific structures and specific positions of the first radiator 21a and the feeding structure 21b.

For example, at least one first radiator 21a may have a passive electromagnetic cancellation structure, including but not limited to a structural feature such as a stub or a slot. The passive electromagnetic cancellation structure is configured to reduce or eliminate blockage of a radiation signal of the second antenna array 2B by the first antenna array 2A. Based on a requirement, the passive electromagnetic cancellation structure may not be provided.

As shown in FIG. 4, in an implementation, the feeding structure 21b may pass through the metasurface lens 22, and is connected to a feeding network 23 located on a side of the metasurface lens 22 facing the second antenna array 2B.

Refer to FIG. 4. In another implementation, the feeding structure 21b does not need to pass through the metasurface lens 22, but is located on a side of the metasurface lens 22 facing the first radiator 21a. The feeding structure 21b may be connected to the metasurface lens 22. In this implementation, the feeding network 23 and the feeding structure 21b are located on a same side of the metasurface lens 22, and the feeding network 23 is connected to the feeding structure 21b.

In this embodiment, the metasurface lens 22 may be used as a reflector plate of the first antenna array 2A (which will be further described below).

As shown in FIG. 4, the second antenna array 2B may include a plurality of second radiating elements 24 arranged according to a specific rule. Frequency bands of the second radiating elements 24 may be consistent, or a frequency band of at least one second radiating element 24 is different from a frequency band of another second radiating element 24. The second radiating element 24 may include a second radiator 24a and a feeding structure 24b, and the second radiator 24a the feeding structure 24b are connected to each other. It may be understood that, in FIG. 4, a horizontal line represents the second radiator 24a, and a vertical line represents the feeding structure 24b. This is merely an example, and is not intended to limit specific structures and specific positions of the second radiator 24a and the feeding structure 24b. The second antenna array 2B may have a corresponding reflector plate and a corresponding feeding network, and each second radiating element 24 may be mounted on the reflector plate.

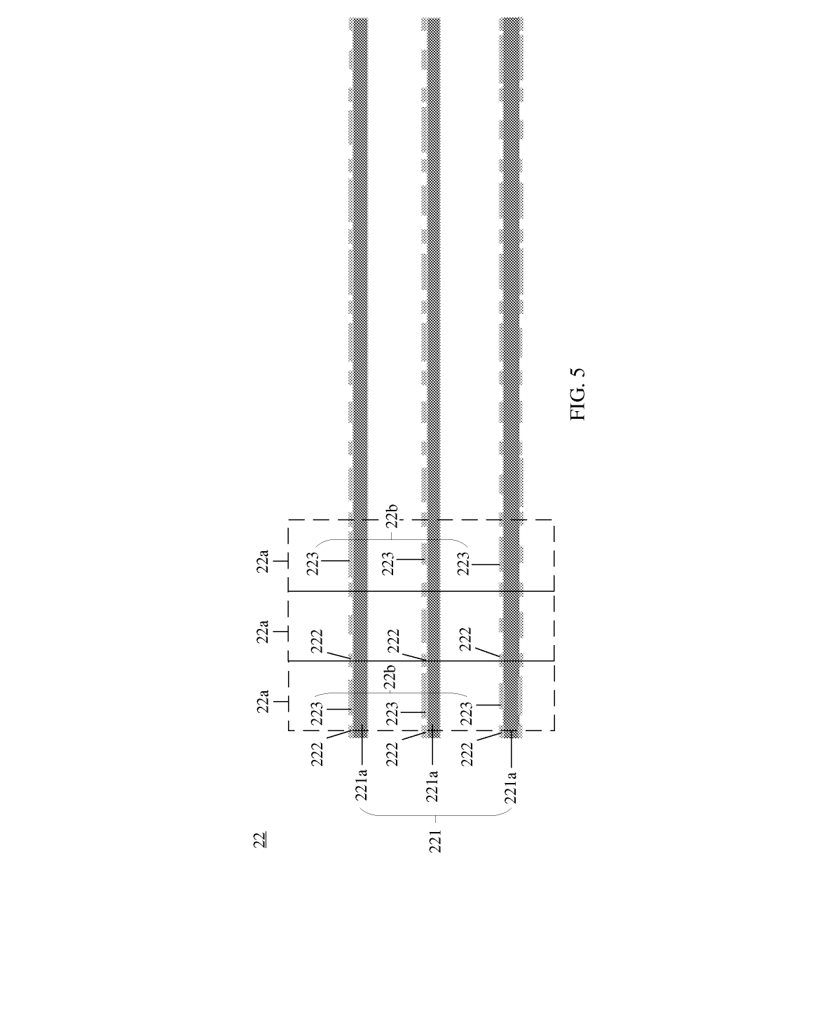

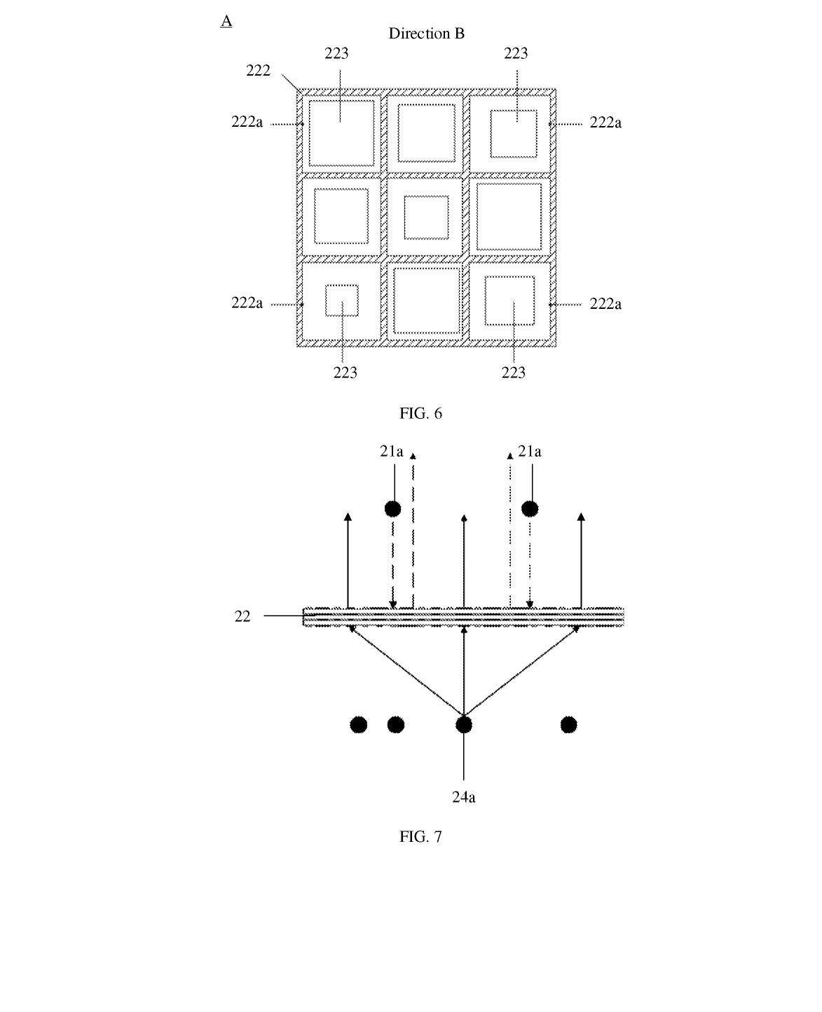

FIG. 5 shows an exploded structure of the metasurface lens 22 in FIG. 4. FIG. 6 is a diagram of a structure of a position A viewed in a direction B in FIG. 4.

As shown in FIG. 5, in an implementation, the metasurface lens 22 may be of a multi-layer structure, and may include a plurality of dielectric sub-layers 221a that are sequentially stacked. These dielectric sub-layers 221a may form an entire dielectric layer 221. The dielectric sub-layer 221a is an insulation dielectric material, and may be, for example, a PCB (Printed Circuit Board, printed circuit board) substrate. The plurality of dielectric sub-layers 221a may be, for example, formed by lamination by using a PCB fabrication process, or may be assembled by using a threaded connector. A metal grid 222 may be formed at each dielectric sub-layer 221a, and the metal grid 222 may be arranged in an intersecting manner. Metal grids 222 on all of the dielectric sub-layers 221a may substantially overlap. To be specific, when projected along a thickness direction (for example, a vertical direction in FIG. 5), the metal grids 222 on all of the dielectric sub-layers 221a may substantially coincide. As shown in FIG. 6, the metal grid 222 may enclose a plurality of regions 222a, and a shape of the region 222a may be determined based on a requirement, including but not limited to a rectangle, a diamond, a hexagon, and the like.

As shown in FIG. 5, for the dielectric layer 221 as a whole, two opposite sides of each dielectric sub-layer 221a along the thickness direction each are provided with a plurality of metasurface patterns 223, and two adjacent dielectric sub-layers 221a may share a metasurface pattern 223. It may be understood that the first two dielectric sub-layers 221a in FIG. 5 each have a metasurface pattern 223 only on an upper side, and this is merely an illustration. As shown in FIG. 5 and FIG. 6, when projected along the thickness direction, a projection of one metasurface pattern 223 may fall within a projection of one region 222a, in other words, one metasurface pattern 223 may be located in one region 222a, and a specific gap exists between each metasurface pattern 223 and a peripheral boundary of a corresponding region 222a.

In this implementation, the metasurface pattern 223 is a structural feature having a specified shape, including but not limited to a square ring, a circular ring, a cross (for example, a Jerusalem cross), a grid square ring, a rectangle (which may also be referred to as a patch), a cross dipole, a trident shape, and the like. The metasurface pattern 223 has a conductive property. For example, the metasurface pattern 223 may be a metal pattern etched on a PCB.

In this implementation, structures (including external shapes and internal structures) of all of metasurface patterns 223 on a same dielectric sub-layer 221a may be substantially consistent or may not be completely the same. The "not be completely the same" means that a structure of at least one metasurface pattern 223 is different from a structure of another metasurface pattern 223, or structures of all of the metasurface patterns 223 are different.

In this implementation, with reference to FIG. 5 and FIG. 6, all of the metasurface patterns 223 that are located in the plurality of overlapping regions 222a along the thickness direction may form a metasurface unit 22b. There may be a plurality of metasurface units 22b. Structures of all of the metasurface patterns 223 on a same metasurface unit 22b may be substantially consistent or may not be completely the same. The "not be completely the same" means that a structure of at least one metasurface pattern 223 is different from a structure of another metasurface pattern 223, or structures of all of the metasurface patterns 223 are different. In this implementation, each metasurface pattern 223 on the metasurface unit 22b may be equivalent to a resonator. Connecting the plurality of metasurface patterns 223 (or referred to as a plurality of resonators) in series can enable the metasurface unit 22b to achieve a specified phase shift. A design of the metasurface pattern 223 on the metasurface unit 22b may be determined based on a phase shift to be imparted to an electromagnetic wave that passes through the metasurface unit 22b. The structures of the metasurface patterns 223 on the metasurface unit 22b are substantially consistent or are not completely the same, so that a corresponding phase shift can be imparted to the electromagnetic wave that passes through the metasurface unit 22b, to meet a product requirement.

It is easy to understand from the foregoing descriptions that, when projected along the thickness direction, the projection of one metasurface unit 22b may fall within the projection of one region 222a, in other words, one metasurface unit 22b may be located in one region 222a, and the specific gap exists between each metasurface unit 22b and the peripheral boundary of the corresponding region 222a. As shown in FIG. 5 and FIG. 6, one metasurface unit 22b and a part of a metal grid disposed around a periphery of the metasurface unit 22b may form one metasurface lens unit 22a, and the entire metasurface lens 22 includes a plurality of metasurface lens units 22a.

In another implementation, refer to FIG. 5. The dielectric layer 221 still includes a plurality of dielectric sub-layers 221a, but a metal grid 222 is formed only on a part of the dielectric sub-layers 221a, and there is no metal grid 222 on the other part of the dielectric sub-layers 221a. For example, the metal grid 222 is formed only on a topmost dielectric sub-layer 221a (where the dielectric sub-layer 221a is closest to the first radiator 21a). Certainly, two opposite sides of each dielectric sub-layer 221a along the thickness direction each are provided with a plurality of metasurface patterns 223.

In another implementation, the dielectric layer 221 may include only one dielectric sub-layer 221a, or the dielectric sub-layer 221a is the dielectric layer 221. In this case, the dielectric layer 221 is provided with a metal grid 222, and two opposite sides of the dielectric layer 221 along the thickness direction each are provided with a plurality of metasurface patterns 223.

In this embodiment, the metasurface lens 22 has a frequency selective characteristic (or referred to as a band-pass characteristic), and can be transmissive for incident waves in some frequency bands and reflective for incident waves in some other frequency bands, so that transmission and reflection of an incident electromagnetic wave can be effectively controlled. The metasurface lens 22 having the multi-layer structure may be used as a multi-order spatial filter, to expand bandwidth and improve frequency selectivity. The metal grid 222 in the metasurface lens 22 may reflect a radiation signal of the first antenna array 2A, so that the metasurface lens 22 is equivalent to the reflector plate of the first antenna array 2A. The metasurface lens 22 further allows transmission of the radiation signal of the second antenna array 2B. Each metasurface unit 22b in the metasurface lens 22 may be equivalent to a capacitive and/or inductor circuit, so that a corresponding phase response is generated (a phase shift is generated) when the radiation signal of the second antenna array 2B passes through the metasurface unit 22b. Therefore, the metasurface unit 22b may perform wavefront phase modulation on the radiation signal of the second antenna array 2B, and approximately focus the radiation signal of the second antenna array 2B into a plane wave, that is, cause the radiation signal of the second antenna array 2B to closely approximate an ideal plane wave.

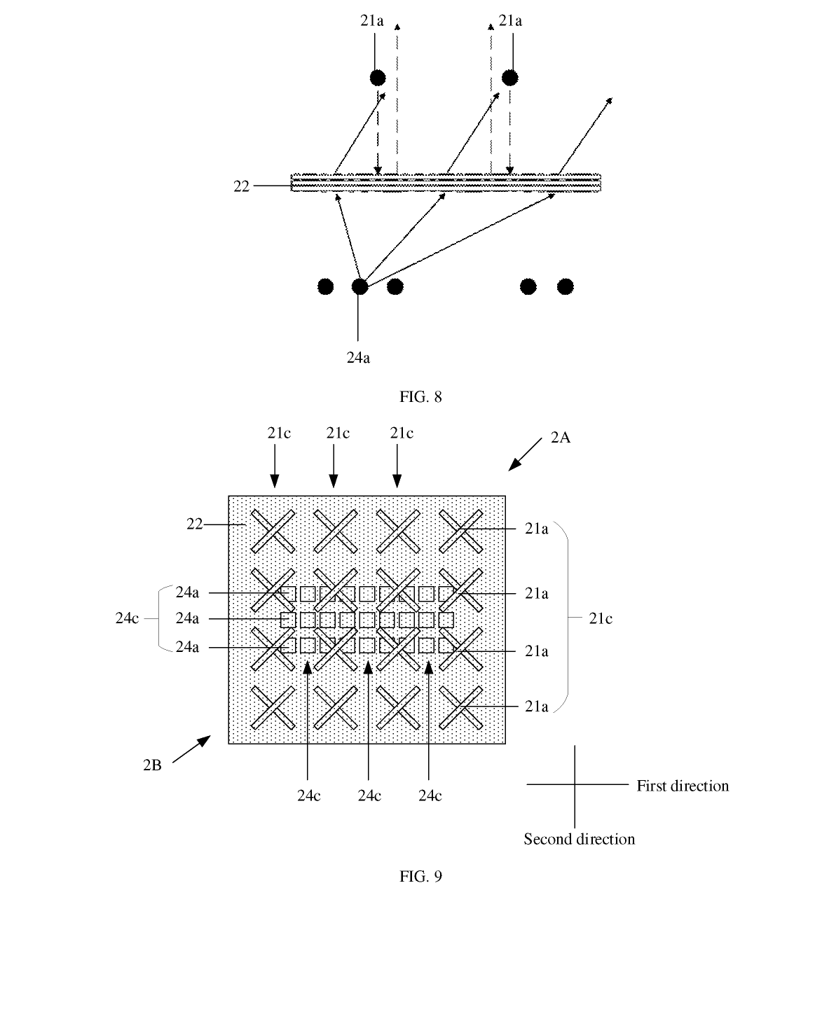

FIG. 7 and FIG. 8 each are a diagram of reflection and focusing functions of the metasurface lens 22. The first radiator 21a in the first antenna array 2A and the second radiator 24a in the second antenna array 2B are represented by using dots. An incident wave and a reflected wave of the first antenna array 2A are represented by using dashed lines. An incident wave and a transmitted wave of the second antenna array 2B are represented by using solid lines.

As shown in FIG. 7, the metasurface lens 22 has a reflective effect on the radiation signal of the first antenna array 2A. The metasurface lens 22 has a focusing function on an incident wave of a second radiator 24a located at a focal point of the metasurface lens 22. After passing through the metasurface lens 22, a radiation signal emitted by the second radiator 24a approximately becomes a plane wave along a normal direction of the metasurface lens 22, to improve a gain of the second antenna array 2B.

As shown in FIG. 8, the metasurface lens 22 has a focusing function on an incident wave of a second radiator 24a that is away from a focal point of the metasurface lens 22. After passing through the metasurface lens 22, a radiation signal emitted by the second radiator 24a becomes a plane wave that is transmitted along an oblique direction, to improve a gain of the second antenna array 2B. Such focusing may also be considered as deflection of the radiation signal of the second antenna array 2B, and may expand a beam sweeping range of the second antenna array 2B.

In the solution of this embodiment, the metasurface lens 22 is disposed between the first antenna array 2A and the second antenna array 2B, and through reflection, transmission, and wavefront phase modulation by the metasurface lens 22, both the first antenna array 2A and the second antenna array 2B can operate, to implement a shared-aperture array antenna. Because the metasurface lens 22 does not block the second antenna array 2B located behind the first antenna array 2A, defects of mutual blockage of antennas and mutual interference in antenna performance in a conventional solution are avoided. The first antenna array 2A, the metasurface lens 22, and the second antenna array 2B are properly assembled, so that structural interference can be avoided. Particularly, antenna arrays on different frequency bands can be independently deployed, to implement a decoupled design and flexible deployment of antennas on different frequency bands.

In the solution of this embodiment, through the wavefront phase modulation by the metasurface lens 22, the radiation signal of the second antenna array 2B can be approximately focused into the plane wave, the gain of the second antenna array 2B can be improved, and the beam sweeping range of the second antenna array 2B can be expanded.

The solution in this embodiment can resolve a problem of antenna installation platform integration. A specific application system and/or application scenario may include the following.

(1) Scenario of antenna installation platform integration for a base station antenna

In the 5G and 5.5G eras, constraints on an antenna installation platform of a base station have become increasingly severe. In addition, in an unconstrained case, an antenna mounting height is low. Consolidating two or more antenna installation platforms into one antenna installation platform based on an antenna installation platform integration technology may resolve the foregoing problem. A multi-band shared-aperture antenna is an important component and research direction of the antenna installation platform integration.

(2) Radar antenna

It is difficult for a single-band antenna to achieve a compromise between an illumination range and search precision/imaging resolution, and using multi-band antennas in combination can ensure high search precision/imaging precision while ensuring the illumination range. Similar to a base station antenna, separate apertures occupy a large area and are not conducive to full exploitation of advantages of antenna combination. A shared-aperture antenna becomes an important choice for the radar antenna and a preferred solution for a synthetic aperture radar antenna.

The following describes two specific solutions in embodiments of this application by using examples.

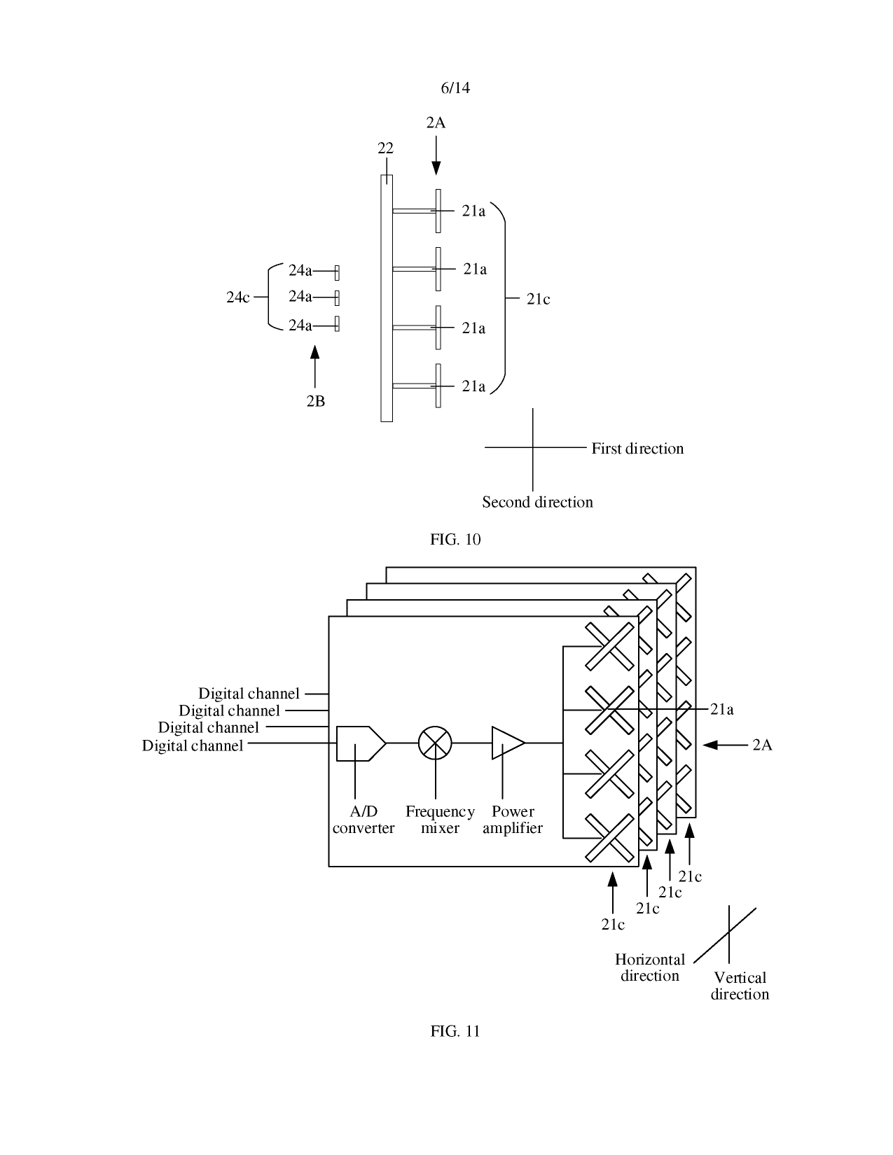

FIG. 9 and FIG. 10 each show a positional relationship among a first radiator 21a, a metasurface lens 22, and a second radiator 24a in a base station antenna in Embodiment 1. FIG. 9 shows a top-view planar positional relationship. FIG. 10 shows a side-view positional relationship.

As shown in FIG. 9 and FIG. 10, for example, first radiators 21a in a first antenna array 2A may be arranged in an array along a first direction and a second direction respectively. Each column extending along the second direction may be referred to as a group 21c. Each group 21c may include a plurality of first radiators 21a that are sequentially arranged along the second direction. A plurality of groups 21c may be sequentially arranged along the first direction. For example, the first radiator 21a may form dual polarization, for example, +45° polarization and –45° polarization.

As shown in FIG. 9 and FIG. 10, second radiators 24a in a second antenna array 2B may be arranged in an array along the first direction and the second direction respectively. Each column extending along the second direction may be referred to as a group 24c. Each group 24c may include a plurality of second radiators 24a that are sequentially arranged along the second direction. A plurality of groups 24c may be sequentially arranged along the first direction.

FIG. 11 shows a circuit architecture used by the first antenna array 2A in Embodiment 1. The architecture may be referred to as a digital beamforming (Digital Beamforming, DBF) architecture. As shown in FIG. 11, each group 21c may be connected to one digital channel. The digital channel may include a plurality of components, including but not limited to an A/D converter, a frequency mixer, a power amplifier, and the like. The components in the digital channel are electrically connected to all of the first radiators 21a in each group 21c. It may be understood that the groups 21c in FIG. 11 are arranged in a stacked manner, and this is merely an example for ease of drawing the accompanying drawings. Actually, arrangement of the groups 21c is the same as that shown in FIG. 9 and FIG. 10. Each digital channel may control a phase of a radiation signal of a corresponding group 21c based on a phase shift that needs to be preconfigured, and all of digital channels operate together, to implement horizontal beam sweeping of the first antenna array 2A. For the base station antenna, a horizontal direction is a direction parallel to the ground, and a vertical direction is a direction perpendicular to the ground. The DBF architecture used by the first antenna array 2A may be consistent with an architecture used by an active antenna unit (Active Antenna Unit, AAU) of a base station. For example, to reduce impact of the first antenna array 2A on the second antenna array 2B, the first radiator 21a in the first antenna array 2A may be in a form of a dipole or a low-scattering element.

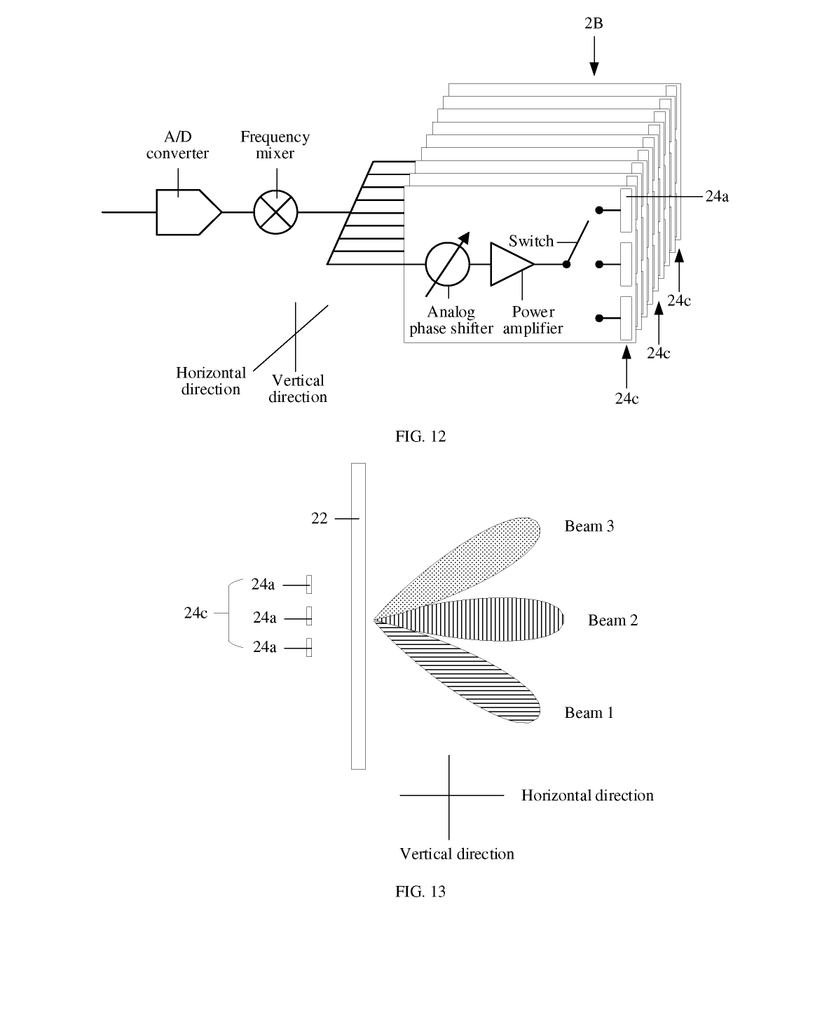

FIG. 12 shows a circuit architecture used by the second antenna array 2B in Embodiment 1. The architecture may be referred to as an analog beamforming (Analog Beamforming, ABF) architecture. A horizontal spacing of the architecture is, for example, about 0.5 wavelength, and a vertical spacing of the architecture may be determined based on a requirement. As shown in FIG. 12, each group 24c may be connected to one analog channel. The analog channel may include a plurality of components, including but not limited to an A/D converter, a frequency mixer, an analog phase shifter, a power amplifier, a switch, and the like. The switch may be a multi-throw switch. The analog phase shifter in the analog channel may be electrically connected to all of second radiators 24a in one group 24c through the switch. The analog phase shifter in each analog channel may adjust a phase of a radiation signal of a corresponding group 24c based on a requirement (for example, based on a preconfiguration), to implement horizontal beam sweeping of the second antenna array 2B. That is, the horizontal beam sweeping of the second antenna array 2B is performed in a phase-controlled manner. The switch in each analog channel may be switched to a specific second radiator 24a in each group 24c based on a requirement (for example, based on a preconfiguration), to "activate" the second radiator 24a, so that the second radiator 24a radiates a signal. With reference to FIG. 12, FIG. 7, and FIG. 8, vertical beam sweeping of the second antenna array 2B may be implemented based on switching of the switch and a focusing function of the metasurface lens 22. That is, the vertical beam sweeping of the second antenna array 2B is performed in a switching manner. FIG. 13 shows the vertical beam sweeping of the second antenna array 2B. As shown in FIG. 13, when the switch is switched to an uppermost second radiator 24a, the second antenna array 2B may emit a beam 1; when the switch is switched to a middle second radiator 24a, the second antenna array 2B may emit a beam 2; and when the switch is switched to a lowermost second radiator 24a, the second antenna array 2B may emit a beam 3.

As shown in FIG. 12, one group 24c in the second antenna array 2B corresponds to one analog channel. That is, a plurality of second radiators 24a may share one analog channel (in other words, a radiating element is decoupled from the analog channel). In this way, a quantity of channels can be reduced, to reduce costs and power consumption.

In Embodiment 1, the first antenna array 2A uses the DBF architecture, and the second antenna array 2B uses the ABF architecture. This may be compatible with a design of an existing base station antenna. Both the first antenna array 2A and the second antenna array 2B may have functions such as dual polarization and beam sweeping.

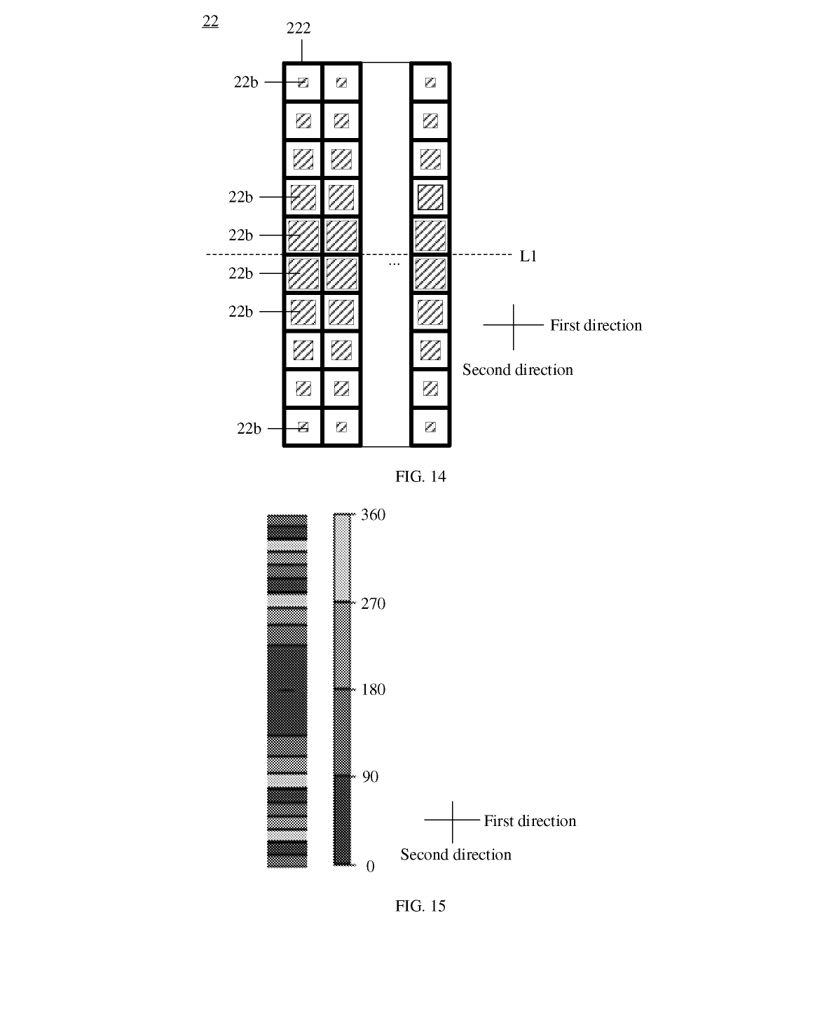

FIG. 14 shows a distribution pattern of metasurface units 22b of the metasurface lens 22 in Embodiment 1. As shown in FIG. 14, the metasurface lens 22 has a first symmetry axis L1 extending along the first direction, and the metasurface units 22b are distributed in an array along the first direction and the second direction, and each column along the second direction in the array is symmetric about the first symmetry axis L1. The "symmetric" means that structures of metasurface units 22b at corresponding positions on two sides of the first symmetry axis L1 are substantially consistent, and the metasurface units 22b are substantially axisymmetrically distributed on the two sides of the first symmetry axis L1. For each column along the first direction in the array, structures of all of the metasurface units 22b are substantially consistent, in other words, all of the metasurface units 22b are periodically replicated along the first direction. It should be understood that FIG. 14 focuses on the foregoing symmetric design and periodical replication design of the metasurface units 22b, and is not intended to limit a structure of a metasurface unit 22b at each position of the metasurface lens 22. As shown in FIG. 14, an area of a metasurface unit 22b closer to the first symmetry axis L1 is larger, and an area of a metasurface unit 22b farther from the first symmetry axis L1 is smaller. This is merely an example. This embodiment is not limited thereto.

The distribution pattern of the metasurface units 22b shown in FIG. 14 can meet a wavefront phase modulation requirement for the radiation signal of the second antenna array 2B, and approximately focus the radiation signal of the second antenna array 2B into a plane wave, to improve a gain of the second antenna array 2B. An increase in the gain of the second antenna array 2B also helps reduce a quantity of radio frequency channels, to reduce power consumption and costs of a device.

FIG. 15 shows a phase distribution generated in a frequency band of the second antenna array 2B by each column of metasurface units 22b in the metasurface lens 22 arranged along the second direction, corresponding to the design shown in FIG. 14. A left figure represents a specific column of metasurface units 22b arranged along the second direction in the metasurface lens 22. A right figure represents, by using different color blocks, phase shifts that can be superimposed. As shown in FIG. 15, a phase shift that can be superimposed on a middle part of the column of metasurface units 22b is large, and a phase shift that can be superimposed decreases toward two sides of the column.

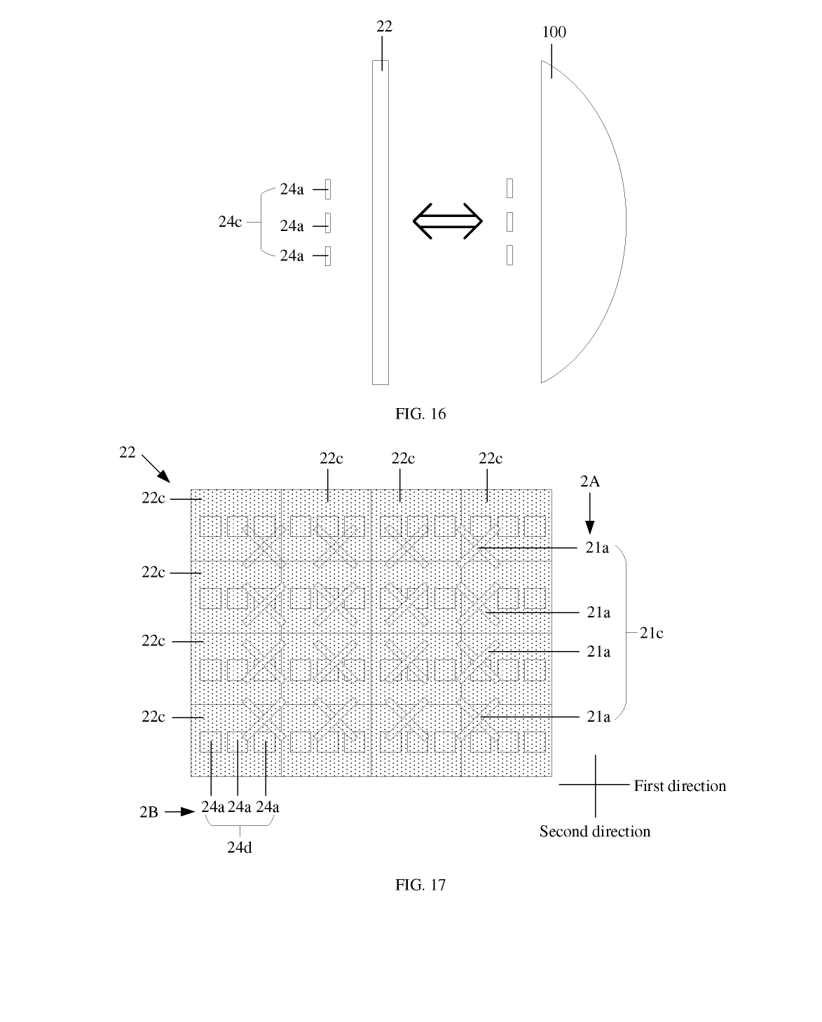

The phase distribution of the metasurface lens 22 shown in FIG. 15 is similar to a phase distribution of a lens, and the metasurface lens 22 may be equivalent to a lens 100 shown in FIG. 16. A phase shift that can be superimposed on a middle part of the lens 100 is large, and a phase shift that can be superimposed decreases toward an edge of the lens 100. The metasurface lens 22 can approximately focus an electromagnetic wave emitted by the second antenna array 2B (where the second antenna array 2B is a feed in comparison with the metasurface lens 22) into a plane wave, to improve a gain of the second antenna array 2B. It may be understood that FIG. 15 and FIG. 16 are examples based on the metasurface lens 22 shown in FIG. 14. In another implementation, a distribution pattern of the metasurface units 22b in the metasurface lens 22 may be adjusted based on a requirement, to obtain a corresponding phase distribution of the metasurface lens 22.

In conclusion, the solution of Embodiment 1 may have the following advantages:

(a) Array antennas of different frequencies are decoupled and arranged, and can be flexibly deployed.

Because the metasurface lens 22 has low manufacturing costs, the metasurface lens 22 and the first antenna array 2A can be deployed as a whole. When a frequency band 1 antenna is needed, only a feed array of the second antenna array 2B needs to be mounted on a back of the first antenna array 2A. Therefore, deployment flexibility is high.

(b) Deployment is easy, and deployment costs are low.

For a problem that design complexity is high and performance is not fully released due to deep coupling of a design of a multi-band shared-aperture antenna, based on descriptions of (a), an antenna design problem is transformed into a design problem of two or more single-band antennas, so that the design is simplified, and performance is fully released.

(c) The second antenna array 2B has a high gain and a small quantity of active channels.

Because the metasurface lens 22 has a beam focusing function, a frequency band 2 antenna may obtain a high gain. With reference to technologies such as the design of the metasurface lens 22, feed switching, phased sweeping, the frequency band 2 antenna can greatly reduce a quantity of required channels when achieving same performance as that of a conventional phased array.

(d) A plurality of functions are supported.

For a problem that most multi-band shared-aperture array antennas do not support functions such as dual polarization and beam sweeping, both the frequency band 1 antenna and the frequency band 2 antenna of a shared-aperture array according to the foregoing solution have a plurality of functions such as dual polarization and beam sweeping.

A difference between Embodiment 2 and Embodiment 1 lies in that the second antenna array 2B is divided into a plurality of sub-arrays, a two-stage sweeping manner is used, and the metasurface lens 22 is also correspondingly divided into a plurality of lens regions. The following provides detailed descriptions.

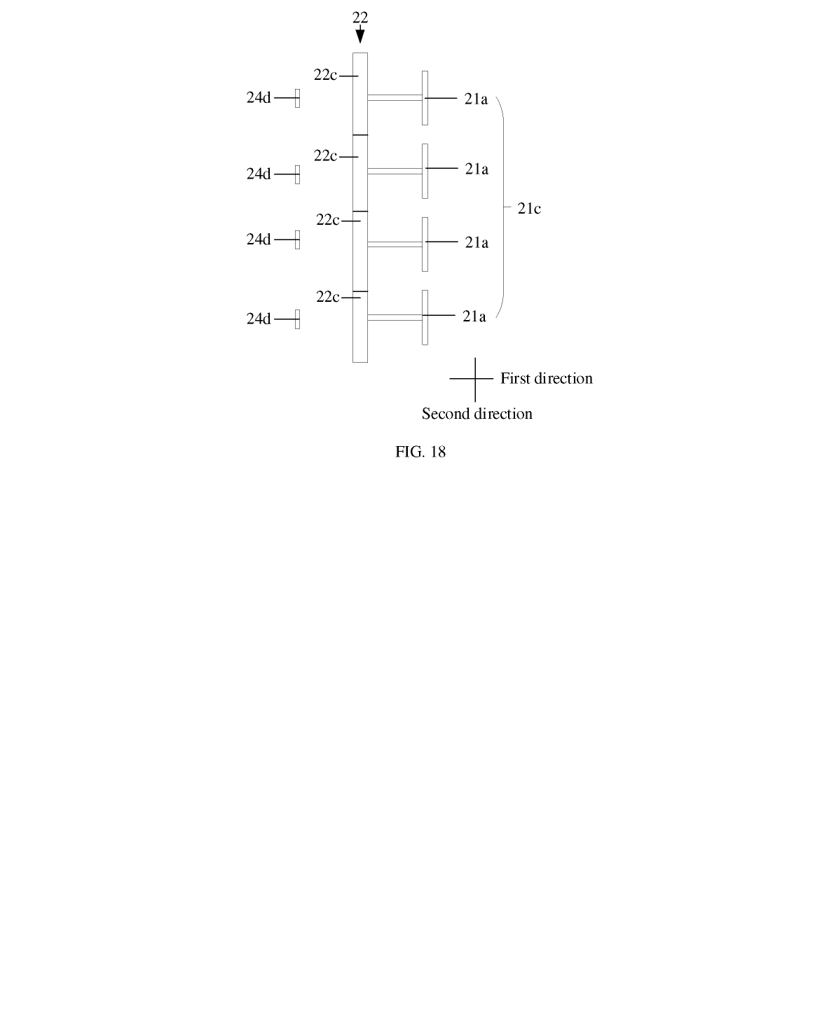

FIG. 17 and FIG. 18 each show a positional relationship among a first radiator 21a, a metasurface lens 22, and a second radiator 24a in a base station antenna in Embodiment 2. FIG. 17 shows a top-view planar positional relationship. FIG. 18 shows a side-view positional relationship.

As shown in FIG. 17 and FIG. 18, for example, first radiators 21a in a first antenna array 2A may be arranged an array along a first direction and a second direction respectively. Each column extending along the second direction may be referred to as a group 21c. Each group 21c may include a plurality of first radiators 21a that are sequentially arranged along the second direction. A plurality of groups 21c may be sequentially arranged along the first direction. For example, the first radiator 21a may form dual polarization, for example, +45° polarization and –45° polarization.

As shown in FIG. 17 and FIG. 18, a second antenna array 2B may include a plurality of antenna sub-arrays 24d, and these antenna sub-arrays 24d are arranged in an array along the first direction and the second direction respectively. Each antenna sub-array 24d includes a plurality of second radiators 24a arranged along the first direction. Because the second antenna array 2B is divided into the plurality of antenna sub-arrays 24d, a horizontal spacing between the antenna sub-arrays 24d may be 1.5 wavelengths. However, the large horizontal spacing causes a severe grating lobe during horizontal beam sweeping. This is not conducive to implementing wide-angle horizontal beam sweeping (for example, sweeping in a ±60° range). To reduce the grating lobe, the two-stage sweeping manner may be used (which is further described below).

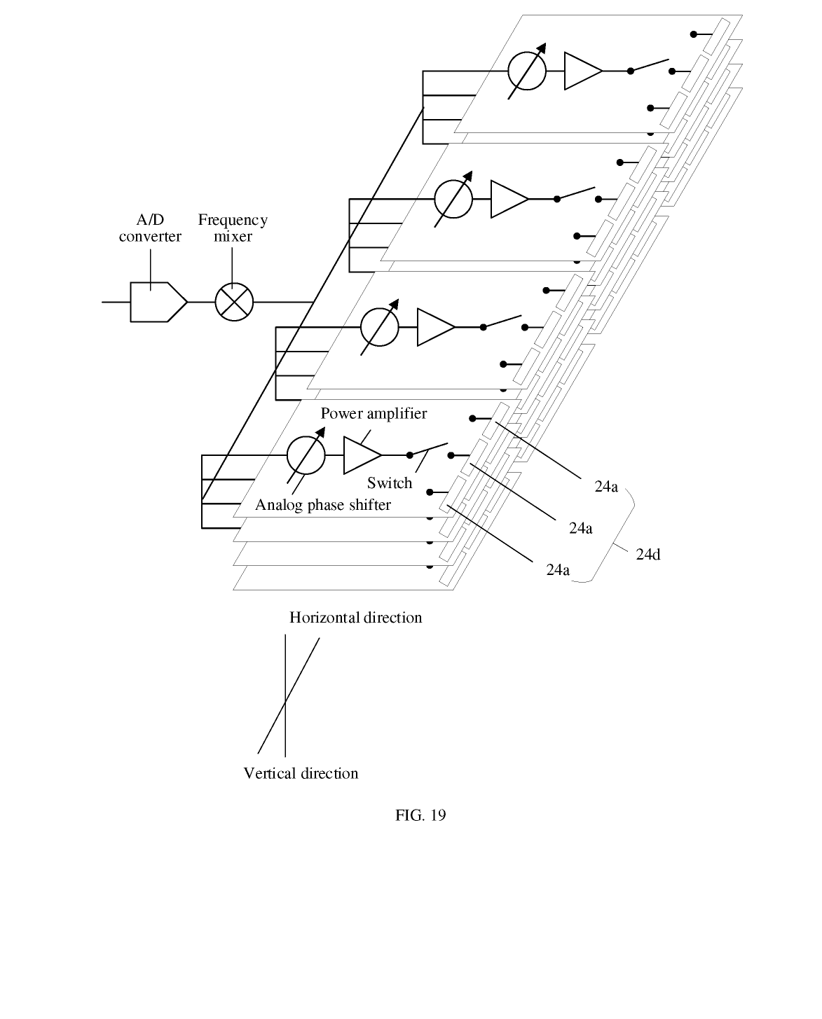

FIG. 19 shows an ABF circuit architecture used by the second antenna array 2B in Embodiment 2. As shown in FIG. 19, each antenna sub-array 24d may be connected to one analog channel. The analog channel may include a plurality of components, including but not limited to an A/D converter, a frequency mixer, an analog phase shifter, a power amplifier, a switch, and the like. The switch may be a multi-throw switch. The analog phase shifter in each analog channel is electrically connected to all of second radiators 24a in one antenna sub-array 24d through the switch. The second antenna array 2B uses a sub-array-level phase-controlled manner in both a vertical direction and a horizontal direction.

Refer to FIG. 19. In the vertical direction, each antenna sub-array 24d corresponds to one analog phase shifter, and each analog phase shifter may adjust a phase of a radiation signal of a corresponding antenna sub-array 24d based on a requirement (for example, based on a preconfiguration), to implement vertical beam sweeping of the second antenna array 2B. That is, the vertical beam sweeping of the second antenna array 2B is performed in a phase-controlled manner.

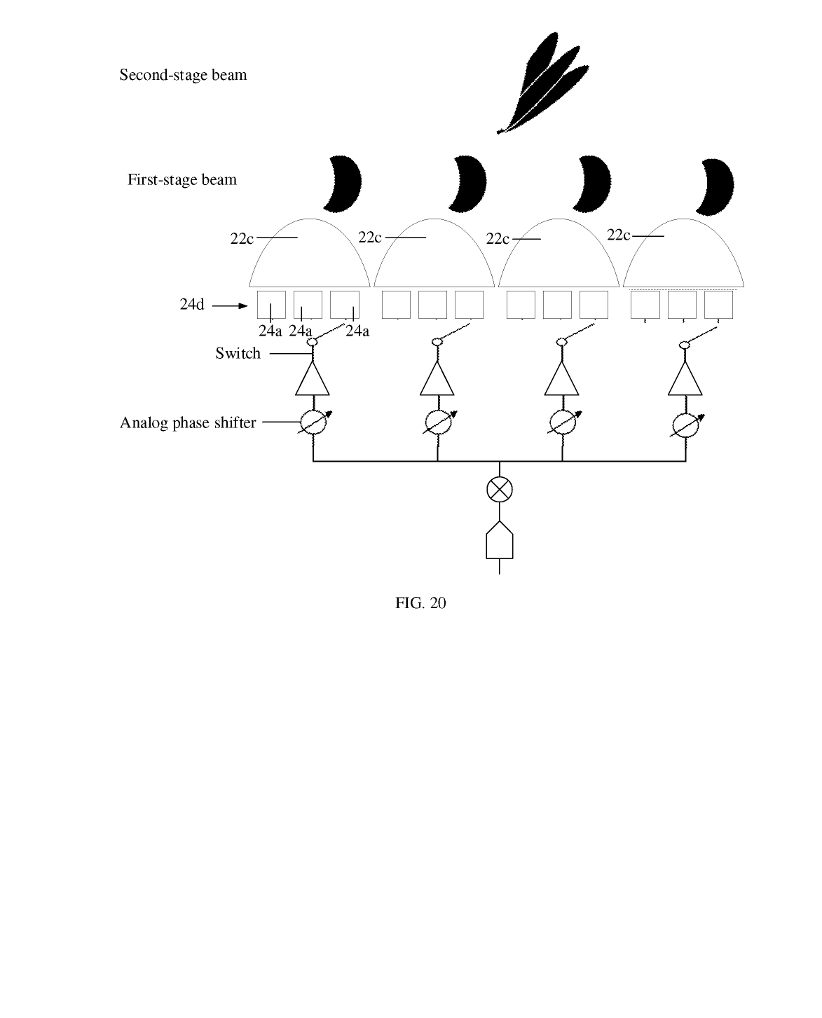

In the horizontal direction, the two-stage sweeping manner may be used to reduce a grating lobe, so as to implement wide-angle horizontal beam sweeping. Specifically, as shown in FIG. 20, switches of analog channels are synchronously switched to second radiators 24a at a same sequential position in the antenna sub-arrays 24d, to implement first-stage horizontal beam sweeping of the second antenna array 2B, and generate a wide first-stage beam. For example, all of the switches are synchronously switched to rightmost second radiators 24a in the antenna sub-arrays 24d. Because of a wave-focusing and deflection effect of the metasurface lens 22, a first-stage beam correspondingly generated by each antenna sub-array 24d is a leftmost beam, and the first-stage beam is wide. Alternatively, phase control may be performed on the second radiators 24a at the same sequential position in the antenna sub-arrays 24d through analog phase shifters of the analog channels, so that each antenna sub-array 24d generates a narrow second-stage beam. For example, phase control is performed on rightmost second radiators 24a in the antenna sub-arrays 24d through the analog phase shifters of the analog channels. Because of a wave-focusing and deflection effect of the metasurface lens 22, a second-stage beam generated by each antenna sub-array 24d is a leftmost beam, and the first-stage beam is narrow. It can be learned that, in the two-stage sweeping manner, the wide first-stage beam of each antenna sub-array 24d is first generated through switching of the switch, and then all of the antenna sub-arrays 24d synthesizes the narrow second-stage beam that has a high gain.

As shown in FIG. 19, one antenna sub-array 24d in the second antenna array 2B corresponds to one analog channel. That is, a plurality of second radiators 24a may share one analog channel (in other words, a radiating element is decoupled from the analog channel). In this way, a quantity of channels can be reduced, to reduce costs and power consumption.

As shown in FIG. 17 and FIG. 18, the metasurface lens 22 may alternatively be divided into a plurality of lens sub-arrays 22c. Each lens sub-array 22c corresponds to one antenna sub-array 24d in the second antenna array 2B. An orthographic projection of the antenna sub-array 24d on the lens sub-array 22c may fall within a boundary of the lens sub-array 22c. As shown in FIG. 20, each lens sub-array 22c may perform wavefront phase modulation on a radiation signal of an antenna sub-array 24d corresponding to the lens sub-array 22c. As described above, the second radiator 24a in the antenna sub-array 24d is activated through switching of the switch. Therefore, when the wavefront phase modulation is performed, the lens sub-array 22c performs modulation on a specific second radiator 24a in the antenna sub-array 24d.

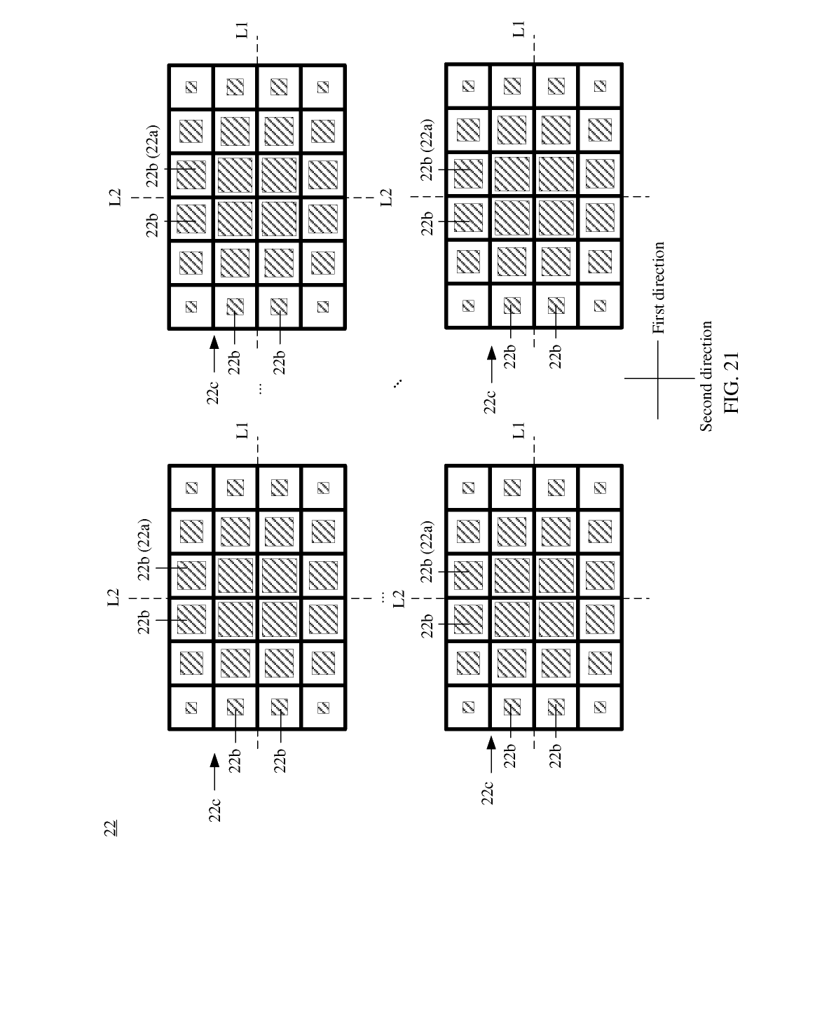

FIG. 21 shows that the metasurface lens 22 is formed by arranging the plurality of lens sub-arrays 22c in an array along the first direction and the second direction respectively. Structures of the lens sub-arrays 22c may be substantially consistent, or the lens sub-arrays 22c are periodically replicated along the first direction and the second direction respectively. As shown in FIG. 21, each lens sub-array 22c includes a plurality of metasurface lens units 22a. Each lens sub-array 22c has a first symmetry axis L1 extending along the first direction and a second symmetry axis L2 extending along the second direction. Metasurface units 22b in the lens sub-array 22c are distributed in an array along the first direction and the second direction respectively. Each column along the second direction in the array is symmetric about the first symmetry axis L1, and each column along the first direction in the array is symmetric about the second symmetry axis L2. That is, the lens sub-array 22c is symmetric about the first symmetry axis L1 and symmetric about the second symmetry axis L2.

It should be understood that FIG. 21 focuses on the foregoing symmetric design and periodical replication design of the metasurface lens 22, and is not intended to limit a structure of a metasurface unit 22b at each position of the metasurface lens 22. As shown in FIG. 21, an area of a metasurface unit 22b closer to the first symmetry axis L1 or the second symmetry axis L2 is larger, and an area of a metasurface unit 22b farther from the first symmetry axis L1 or the second symmetry axis L2 is smaller. This is merely an example. This embodiment is not limited thereto.

A distribution pattern of the metasurface units 22b in the metasurface lens 22 shown in FIG. 21 can adapt to the two-stage beam sweeping manner of the second antenna array 2B, meet a wavefront phase modulation requirement for the radiation signal of the second antenna array 2B, and approximately focus the radiation signal of the second antenna array 2B into a plane wave, to improve a gain of the second antenna array 2B. An increase in the gain of the second antenna array 2B also helps reduce a quantity of radio frequency channels, to reduce power consumption and costs of a device.

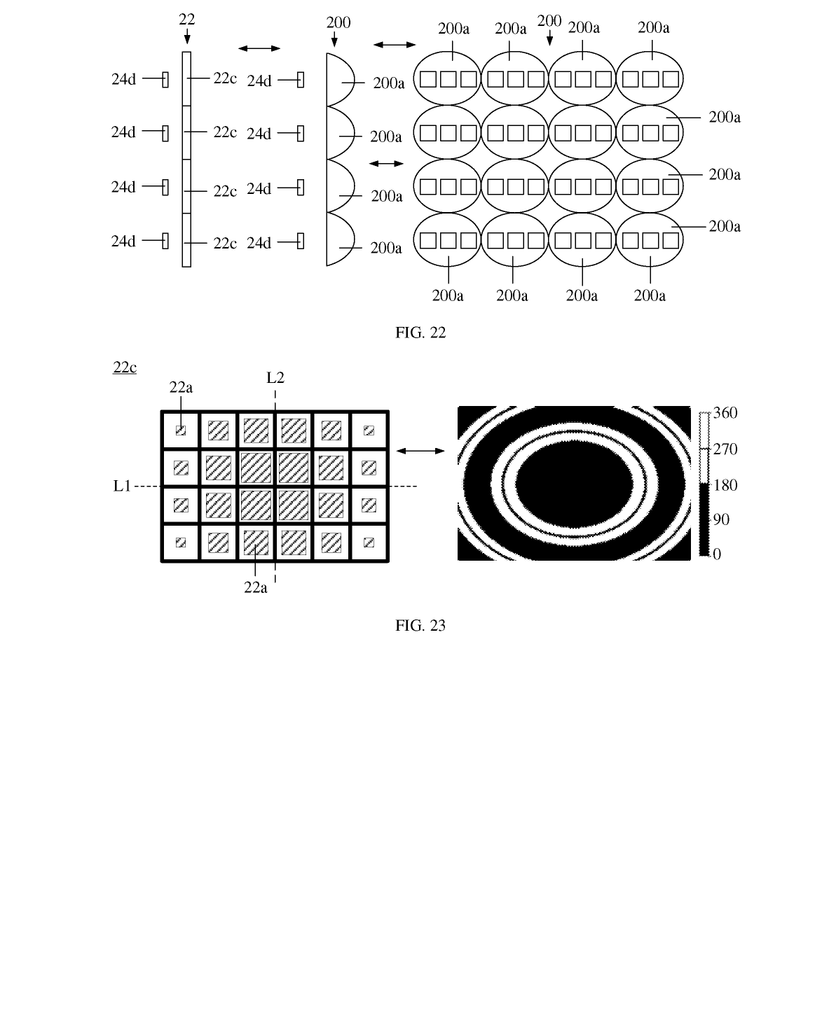

The metasurface lens 22 shown in FIG. 21 may be equivalent to a lens 200 shown in FIG. 22. Each lens sub-array 22c may be equivalent to one sub-lens 200a in the lens 200. One sub-lens 200a corresponds to one antenna sub-array 24d.

FIG. 23 shows a phase distribution generated in a frequency band of the second antenna array 2B by a lens sub-array 22c in the metasurface lens 22, corresponding to the design shown in FIG. 21. The phase distribution is similar to a phase distribution of one sub-lens 200a. A left figure represents the lens sub-array 22c. A right figure represents the phase distribution. Different color blocks represent phase shifts that can be superimposed. As shown in FIG. 22, in the lens sub-array 22c, a phase shift that can be superimposed on a metasurface unit 22b closer to the first symmetry axis L1 and the second symmetry axis L2 is larger, and a phase shift that can be superimposed on a metasurface unit 22b farther from the first symmetry axis L1 or the second symmetry axis L2 is smaller.

Embodiment 2 also has the foregoing advantages of Embodiment 1. For example, array antennas of different frequencies are decoupled and arranged, and can be flexibly deployed; deployment is easy, and deployment costs are low; the second antenna array 2B has a high gain and a small quantity of active channels; and a plurality of functions are supported.

The foregoing describes embodiments of this application in detail. Specific examples are used in this specification to describe the principle and embodiments of this application. The descriptions of the foregoing embodiments are merely intended to help understand the method and the core idea of this application. In addition, a person of ordinary skill in the art may make modifications to the specific embodiments and the application scope according to the idea of this application. Therefore, the content of this specification shall not be construed as a limitation to this application.

1. A base station antenna, comprising:
a first antenna array, a metasurface lens, and a second antenna array, wherein
the metasurface lens is located between a first radiator of a radiating element of the first antenna array and the second antenna array, and the metasurface lens is configured to: reflect a radiation signal of the first antenna array, and perform wavefront phase modulation and transmission on a radiation signal of the second antenna array.

2. The base station antenna according to claim 1, wherein
the base station antenna comprises a feeding structure and a feeding network, both the feeding structure and the feeding network are located on a side of the metasurface lens facing the first radiator, and the feeding structure connects the first radiator and the feeding network.

3. The base station antenna according to claim 1, wherein
the base station antenna comprises a feeding structure and a feeding network, the feeding structure passes through the metasurface lens, the feeding network is located on a side of the metasurface lens facing the second antenna array, and the feeding structure connects the first radiator and the feeding network.

4. The base station antenna according to claim 1, wherein
the metasurface lens comprises a dielectric layer, the dielectric layer is provided with a metal grid, the metal grid is arranged in an intersecting manner and encloses a plurality of regions, each region is provided with one metasurface unit, a specific gap exists between the metasurface unit in each region and a boundary of the region, the metal grid is configured to reflect the radiation signal of the first antenna array, and the metasurface unit is configured to perform wavefront phase modulation and transmission on the radiation signal of the second antenna array.

5. The base station antenna according to claim 4, wherein
the dielectric layer comprises a plurality of dielectric sub-layers that are sequentially stacked, at least one of the dielectric sub-layers is provided with the metal grid, and when at least two of the dielectric sub-layers are provided with the metal grid, the metal grids on all of the dielectric sub-layers overlap; and two opposite sides of each dielectric sub-layer along a thickness direction of the dielectric sub-layer each are provided with a metasurface pattern, and a plurality of metasurface patterns arranged along the thickness direction form one metasurface unit.

6. The base station antenna according to claim 5, wherein
in the plurality of dielectric sub-layers, a surface of a dielectric sub-layer adjacent to the first radiator is provided with the metal grid.

7. The base station antenna according to claim 5, wherein
structures of all of metasurface patterns on a same dielectric sub-layer are not completely the same.

8. The base station antenna according to claim 5, wherein
structures of a plurality of metasurface patterns on a same metasurface unit are not completely the same.

9. The base station antenna according to claim 1, wherein
the first antenna array comprises a plurality of groups of first radiators, and each group of first radiators comprises a plurality of first radiators; and
the base station antenna comprises a plurality of digital channels, each digital channel is electrically connected to all of first radiators in one group of first radiators, and the plurality of digital channels are configured to implement horizontal beam sweeping of the first antenna array by preconfiguring a phase shift.

10. The base station antenna according to claim 9, wherein
the second antenna array comprises a plurality of groups of second radiators arranged along a first direction, each group of second radiators comprises a plurality of second radiators arranged along a second direction, and the second direction is perpendicular to the first direction;
the base station antenna comprises a plurality of analog channels, each analog channel comprises an analog phase shifter and a switch, the analog phase shifter in each analog channel is electrically connected to all of second radiators in one group of second radiators through the switch, and the plurality of analog channels are configured to: implement horizontal beam sweeping of the second antenna array through the analog phase shifter, and implement vertical beam sweeping of the second antenna array by switching the switch; and
the metasurface lens comprises the dielectric layer and the metasurface units, the metasurface lens has a first symmetry axis along the first direction, the metasurface units in the metasurface lens are distributed in an array along the first direction and the second direction, each column along the second direction in the array is symmetric about the first symmetry axis, and structures of the metasurface units in each column along the first direction in the array are the same.

11. The base station antenna according to claim 9, wherein
the second antenna array comprises a plurality of sub-arrays, the plurality of sub-arrays are arranged in an array along a first direction and a second direction, each sub-array comprises a plurality of second radiators arranged along the first direction, and the second direction is perpendicular to the first direction;
the base station antenna comprises a plurality of analog channels, each analog channel comprises an analog phase shifter and a switch, the analog phase shifter in each analog channel is electrically connected to all of second radiators in one sub-array through the switch, the plurality of analog channels are configured to implement vertical beam sweeping of the second antenna array through the analog phase shifter, and the plurality of analog channels are further configured to: implement first-stage horizontal beam sweeping of the second antenna array by switching the switch, and implement second-stage horizontal beam sweeping of the second antenna array through the analog phase shifter; and
the metasurface lens comprises the dielectric layer and the metasurface units, the metasurface lens has a first symmetry axis along the first direction and a second symmetry axis along the second direction, the metasurface units in the metasurface lens are distributed in an array along the first direction and the second direction, each column along the second direction in the array is symmetric about the first symmetry axis, and each column along the first direction in the array is symmetric about the second symmetry axis.

12. The base station antenna according to claim 1, wherein
the first radiator has a passive electromagnetic cancellation structure.

13. The base station antenna according to claim 1, wherein
the base station antenna comprises a first radome and a second radome, the first antenna array and the metasurface lens are located in the first radome, and the second antenna array is located in the second radome.

14. A base station, comprising
a base station antenna, wherein the base station antenna comprises:
a first antenna array, a metasurface lens, and a second antenna array, wherein
the metasurface lens is located between a first radiator of a radiating element of the first antenna array and the second antenna array, and the metasurface lens is configured to: reflect a radiation signal of the first antenna array, and perform wavefront phase modulation and transmission on a radiation signal of the second antenna array.

15. The base station according to claim 14, wherein
the base station antenna comprises a feeding structure and a feeding network, both the feeding structure and the feeding network are located on a side of the metasurface lens facing the first radiator, and the feeding structure connects the first radiator and the feeding network.

16. The base station according to claim 14, wherein
the base station antenna comprises a feeding structure and a feeding network, the feeding structure passes through the metasurface lens, the feeding network is located on a side of the metasurface lens facing the second antenna array, and the feeding structure connects the first radiator and the feeding network.

17. The base station according to claim 14, wherein
the metasurface lens comprises a dielectric layer, the dielectric layer is provided with a metal grid, the metal grid is arranged in an intersecting manner and encloses a plurality of regions, each region is provided with one metasurface unit, a specific gap exists between the metasurface unit in each region and a boundary of the region, the metal grid is configured to reflect the radiation signal of the first antenna array, and the metasurface unit is configured to perform wavefront phase modulation and transmission on the radiation signal of the second antenna array.

18. The base station according to claim 17, wherein
the dielectric layer comprises a plurality of dielectric sub-layers that are sequentially stacked, at least one of the dielectric sub-layers is provided with the metal grid, and when at least two of the dielectric sub-layers are provided with the metal grid, the metal grids on all of the dielectric sub-layers overlap; and two opposite sides of each dielectric sub-layer along a thickness direction of the dielectric sub-layer each are provided with a metasurface pattern, and a plurality of metasurface patterns arranged along the thickness direction form one metasurface unit.

19. The base station according to claim 18, wherein
in the plurality of dielectric sub-layers, a surface of a dielectric sub-layer adjacent to the first radiator is provided with the metal grid.

20. The base station according to claim 18, wherein
structures of all of metasurface patterns on a same dielectric sub-layer are not completely the same.
